(19) United States
(12) Patent Application Publication
(10) Pub. No.: US 2016/0011125 A1
(43) Pub. Date: Jan. 14, 2016

(54) METHOD FOR MEASURING VOLUME RATIO OF EACH CONSTITUENT MEDIUM EXISTING IN MINIMUM UNIT OF X-RAY CT IMAGE FOR SPECIMEN FORMED OF COMPLEX MEDIUMS

(71) Applicant: KOREA INSTITUTE OF CONSTRUCTION TECHNOLOGY, Ilsanseo-gu, Goyang-si, Gyeonggi-do (KR)

(72) Inventors: Hyu Soung SHIN, Goyang-si, Gyeonggi-do (KR); Kwang Yeom KIM, Goyang-si, Gyeonggi-do (KR)

(21) Appl. No.: 14/771,793

(22) PCT Filed: Dec. 18, 2013
(86) PCT No.: PCT/KR2013/011794

§ 371 Date: Aug. 31, 2015

(30) Foreign Application Priority Data
Sep. 26, 2013 (KR) 10-2013-0114407

(51) Int. Cl. G01N 23/04

(52) U.S. Cl. CPC G01N 23/046

(57) ABSTRACT

In performing an X-ray CT scan on a specimen, the volume which each constituent medium accounts for, that is, the volume ratio of the constituent medium mixed in a mixel can be calculated for the corresponding mixel, in which the constituent medium is mixed, among a voxel of the specimen, thereby measuring the volume ratio of each constituent medium existing in the minimum unit in the X-ray CT scan.

### TECHNICAL FIELD

The present disclosure relates to an estimation method for volume fractions of each pure material in a smallest unit of an X-ray Computed Tomography (CT) image of a composite material specimen obtained by X-ray CT scanning.

### BACKGROUND ART

X-ray CT scan is being used in many industrial fields including medical field. Korean Patent No. 10-1120250 discloses a method of processing an image obtained by X-ray CT scanning in the medical field.

Conventional X-ray CT scan equipment works to pass X-rays through an object (specimen) to generate a three dimensional (3D) image of the specimen in a 3D image unit (a voxel unit). In this specification, a process of producing a CT value using X-ray penetration is shortened to “CT scan” for convenience sake, and X-ray CT scan equipment used therefor is shorted to “CT scan equipment” for convenience sake.

In the CT scan of the specimen, it is found that the specimen of 3D shape consists of voxels, known as the basic unit of the 3D image. That is, a smallest basic unit recognizable by CT scan in the image of the specimen is a voxel. When the specimen is a material composite (a composite material) made of a mixture of different types of materials, one voxel in the image of the specimen may consist of one type of pure material while one voxel may consist of a mixture of different types of materials. For example, soil obtained from the ground has pores and air exist in the pores, and therefore, soil is regarded as a mixture of two pure materials, “air” and “aggregates”, i.e., an “air-aggregate” material composite. In this instance, when the specimen of soil is divided into smallest units called voxels, a certain voxel may be occupied by only air or only aggregates, while a certain voxel may be occupied by a mixture of air and aggregates. A voxel consisting of a mixture of different types of materials is referred to as a “mixel”. That is, in the specimen of soil as presented above, the voxel consisting of a mixture of air and aggregates corresponds to a “mixel”.

Conventional CT scan equipment and CT scan method sets a threshold of a CT value for each voxel and classifies each voxel by dichotomy based on the set threshold. FIG. 1 is a conceptual diagram illustrating a process of classifying voxels of a sample by dichotomy in conventional CT scan equipment and CT scan method. When a specimen is divided into “voxels” corresponding to a smallest unit recognizable by X-ray CT scan as shown in (a) of FIG. 1, a certain voxel consists only of a pure material, while a voxel, also known as a mixel, does not consist of a pure material but a mixture of different materials. That is, different types of materials are mixed in the mixel with a predetermined volume fraction.

However, because of voxel classification by dichotomy based on the set threshold, conventional CT scan equipment and CT scan method just classifies each voxel into one of the two as seen in black and white in (b) of FIG. 1 only by determining whether a CT value of each voxel exceeds the threshold. That is, for a mixel consisting of a mixture of different types of materials, conventional technology just classifies the voxel into two classes based on only the threshold of the CT value without considering the volume fraction of the mixed materials in the mixel. Because the volume fraction of the materials in the mixel is not taken into account, the conventional X-ray CT scan equipment and X-ray CT scan method has a technical limitation in that accuracy and reliability is low in the calculation of the volume fraction of the pure materials of the sample.

### DISCLOSURE

### Technical Problem

The present disclosure provides technology that may overcome the limitation of conventional technology which, for a mixel consisting of a mixture of different types of materials, just classifies a voxel into two classes based on only a threshold of a Computed Tomography (CT) value without considering the volume fraction of the mixed materials in the mixel.

Specifically, for each voxel corresponding to a smallest unit of a CT image of a specimen made from a composite material (a material composite) consisting of a mixture of a plurality of pure materials, in other words, for each voxel constituting an image of the specimen, the present disclosure provides a method for calculating the volume fraction occupied by each pure material in a corresponding voxel.

### Technical Solution

The present disclosure provides an estimation method for volume fractions of each pure material in a voxel, by which for each voxel corresponding to a smallest unit in an X-ray Computed Tomography (CT) image of a composite material specimen consisting of a mixture of a plurality of pure materials, volume fraction occupied by each pure material in the corresponding voxel is calculated, the method including: CT scanning using X-ray radiation by CT scan equipment to obtain an X-ray histogram of the composite material specimen; obtaining Gaussian Functions (GFs) representing the obtained X-ray histogram of the composite material and individual GFs constituting the GFs by using a computing device; calculating a difference (L_{i,j}) between a mean value of a GF for each pure material and a mean value of each of the plurality of GFs constituting the GFs representing the X-ray histogram of the composite material, and estimating volume fraction (PR_{i,j}) occupied by each pure material in each Gaussian Function using the calculated L_{i,j} value; and calculating volume fraction (VF) of each pure material for each voxel.

### Advantageous Effects

According to the present disclosure, for each voxel corresponding to a smallest unit of a Computed Tomography (CT) image of a specimen made from a composite material (a material composite) consisting of a mixture of a plurality of pure materials, in other words, for each voxel constituting the CT image of the specimen, the volume fraction occupied by each pure material in a corresponding voxel may be calculated.

According to the present disclosure, for a mixel consisting of a mixture of a plurality of pure materials among the voxels of the specimen, there is an effect of calculating the volume occupied by each pure material, that is, the volume fraction of the pure materials of the mixture in the corresponding mixel.

According to the present disclosure, in the calculation of the volume fraction of each pure material of the specimen based on the voxel, an accurate result of calculating the volume fraction of each pure material may be obtained without being greatly influenced by the size of the voxel, that is, the resolution of the CT image.

Furthermore, according to the present disclosure, the volume fraction of the pure in a voxel (including a mixel) may be estimated, so there are effects of calculating a volume fraction distribution of each pure material in the specimen, which was impossible to attain by dichotomy used in conventional art, and increasing accuracy and reliability of a specimen analysis method using X-ray CT scan.

### DESCRIPTION OF DRAWINGS

FIG. 1 is a conceptual diagram illustrating a process of classifying voxels of a sample by dichotomy in conventional Computed Tomography (CT) scan equipment and CT scan method.

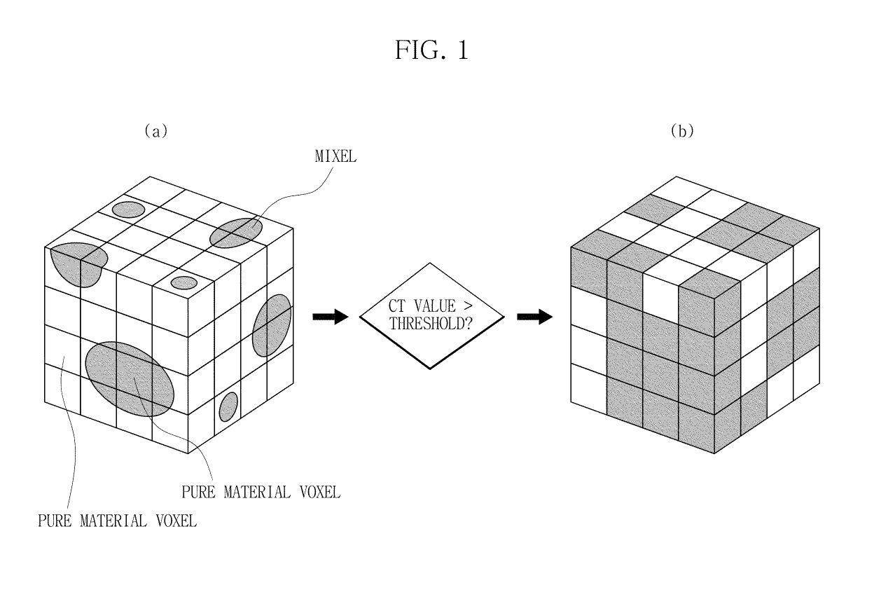

FIG. 2 is an X-ray histogram of a CT value of a sample made from one type of material (pure material).

FIG. 3 is a flowchart showing a schematic process of a method according to the present disclosure.

FIG. 4 is a flowchart of a process of computing and obtaining Gaussian distribution Functions (GFs) representing an X-ray histogram of a composite material through multiple regression analysis.

FIG. 5 is an X-ray histogram of a CT value of a target specimen made from a composite material consisting of a mixture of three kinds of pure materials.

FIG. 6 is an X-ray histogram showing that auxiliary GFs are present in region A and region B in the X-ray histogram shown in FIG. 5.

FIG. 7 is a detailed flowchart of a step for estimating the volume fraction occupied by each pure material in each GF.

FIG. 8 is a conceptual diagram illustrating a process of classifying voxels according to the present disclosure.

### BEST MODE

Hereinafter, the preferred embodiments of the present disclosure will be described with reference to accompanying drawings. While the present disclosure is described with reference to the embodiments shown in the drawings, the description is provided by way of illustration only and the technical aspects of the present disclosure and its core configuration and applications are not limited by such embodiments.

The present disclosure first performs Computed Tomography (CT) scan by passing X-rays through a target specimen for estimation of the volume fraction of a material by known CT scan equipment. The CT scan equipment evaluates the X-ray penetration capability and obtains a unique value in a voxel unit of a CT image of the specimen based on the X-ray penetration capability, and here, the unique value given to each voxel of the CT image of the specimen based on the extent to which X-rays pass through each material in the CT scan equipment is collectively referred to as a “CT value”. Using the CT value automatically calculated by CT scanning by known CT scan equipment, the present disclosure provides an estimation method for volume fractions of a plurality of pure materials of the specimen in a voxel unit by the corresponding CT scan equipment.

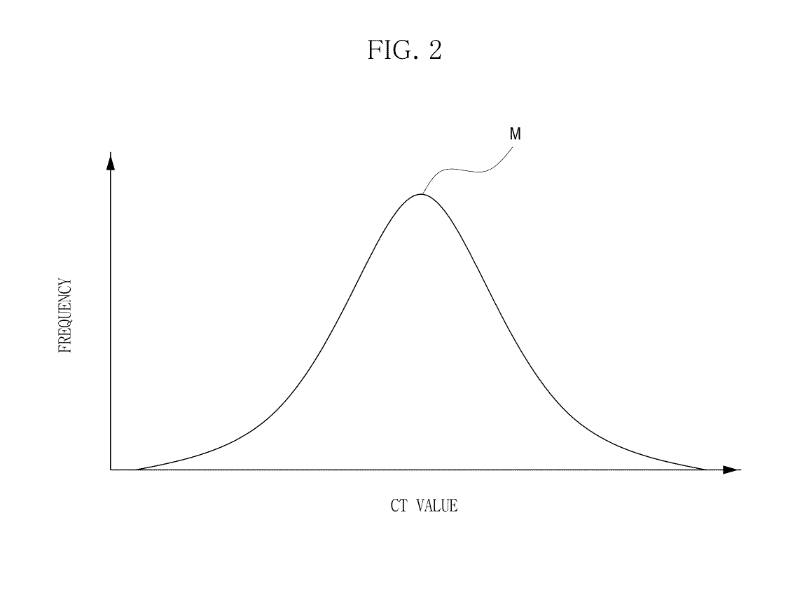

Upon CT scanning the sample using the CT scan equipment, an X-ray CT histogram (hereinafter, shortened to an “X-ray histogram”) of the CT value is obtained, and FIG. 2 shows an example of the X-ray histogram of the specimen made from one material, i.e., a pure material. In the X-ray histogram, an x axis is a “CT value” obtained in a voxel unit by the CT scan equipment, and a y axis is “frequency” of the corresponding CT value, i.e., the number of voxels of the specimen having the corresponding CT value. The X-ray histogram obtained by CT scanning the target specimen has a bell shape, and may be mathematically expressed as a Gaussian distribution Function (hereinafter, shortened to “GF”) defined by a mean value and variance, and an area value of the area under the curve graph. That is, the X-ray histogram of the pure material consisting of one type of material may be represented by one unique GF. In FIG. 2, the drawing symbol M denotes a maximum point (M) in the graph of the bell-shaped X-ray histogram.

On the other hand, a composite material is a mixture of a plurality of pure materials, and a GF of an X-ray histogram of the composite material may be expressed as the sum of unique ratios of each pure material that makes up the composite material.

Based on the above, the present disclosure performs the following steps in a sequential order, and the method of the present disclosure may be performed by a system including an input device, a computing device, and an output device (an imaging device), and input data necessary to perform the method may be inputted by a user through the input device. The computing device may include a computer, and a series of processes included in the method of the present disclosure may be performed by a computer program running on the computing device. Particularly, the computing device may be provided in the CT scan equipment, but may be provided in a separate device connected to the CT scan equipment.

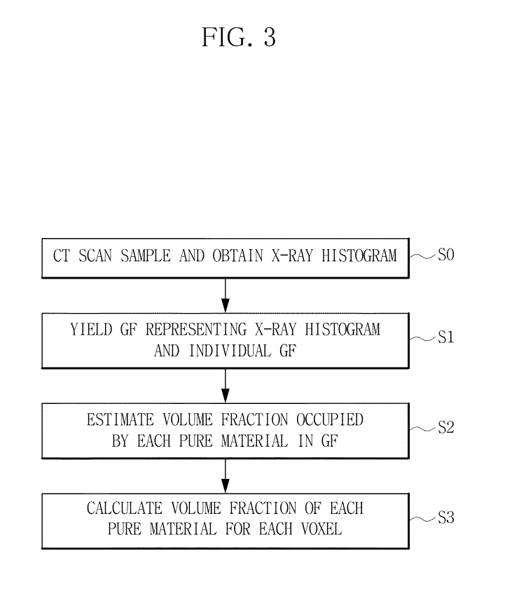

FIG. 3 is a flowchart showing a schematic process of the method according to the present disclosure. The method according to the present disclosure begins with CT scanning using X-ray radiation by known CT scan equipment to obtain an X-ray histogram of a sample (S0), and the computing device produces a GF representing the obtained X-ray histogram (S1). In the case of a pure material, as shown in FIG. 2, the X-ray histogram has a shape of a curve having one maximum value, and the GF is a function defined by a mean value (a mean value in the bell-shaped curve), a variance value, and an area value of the area under the curve, so the GF representing the X-ray histogram of the pure material may be determined by a known mathematical method from the X-ray histogram obtained through CT scan.

However, in the case of a composite material consisting of a mixture of different types of pure materials, the X-ray histogram is not represented as one GF, but the sum of a plurality of GFs with different mean values, variance values, and area values. Thus, the present disclosure computes and produces a plurality of GFs representing the composite material by performing a multiple regression analysis based on the X-ray histogram obtained through CT scan.

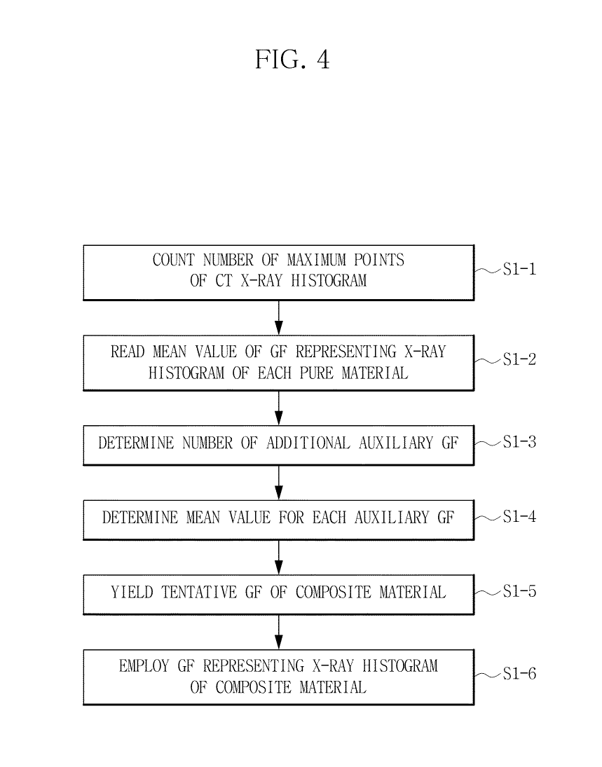

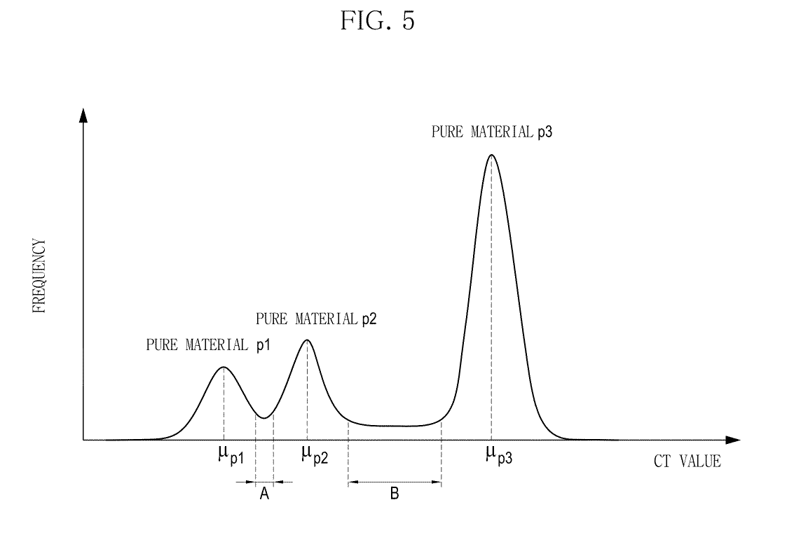

Hereinafter, the foregoing process, i.e., the process of computing and producing GFs representing the X-ray histogram of the composite material through multiple regression analysis by the computing device is described in more detail. FIG. 4 is a flowchart showing the process of computing and producing GFs representing the X-ray histogram of the composite material through multiple regression analysis, and FIG. 5 shows an example of the X-ray histogram of the CT value of the target specimen made from the composite material consisting of a mixture of three types of pure materials. As illustrated in FIG. 5, for example, in the case where the target specimen is made from a composite material (a material composite) consisting of a mixture of three pure materials, the X-ray histogram includes three GFs representing the pure materials and having maximum points. Thus, after obtaining the X-ray histogram of the target specimen, the present disclosure counts the number of maximum points and sets the same as the number of pure materials of the target specimen (S1-1). In the example of FIG. 5, because the target specimen has three maximum points, the target specimen is found made up of the pure materials p1, p2, and p3.

Along with counting the number of maximum points in the X-ray histogram, a CT value at each maximum point is read as a mean value of the GF representing the X-ray histogram of each pure material (S1-2). In the case of FIG. 5, the CT value μ_{P1} at the maximum point of the pure material p1, the CT value μ_{P2} at the maximum point of the pure material p2, and the CT value μ_{P3} at the maximum point of the pure material p3 are respectively read. The read CT value at the maximum point of each pure material becomes a mean value of the GF representing the X-ray histogram of each pure material. That is, the GF is a function defined by a mean value (a mean value in the bell-shaped curve), variance, and an area value of the area under the curve, and the read CT value at the maximum point of each pure material becomes a mean value of the GF representing the X-ray histogram of each pure material.

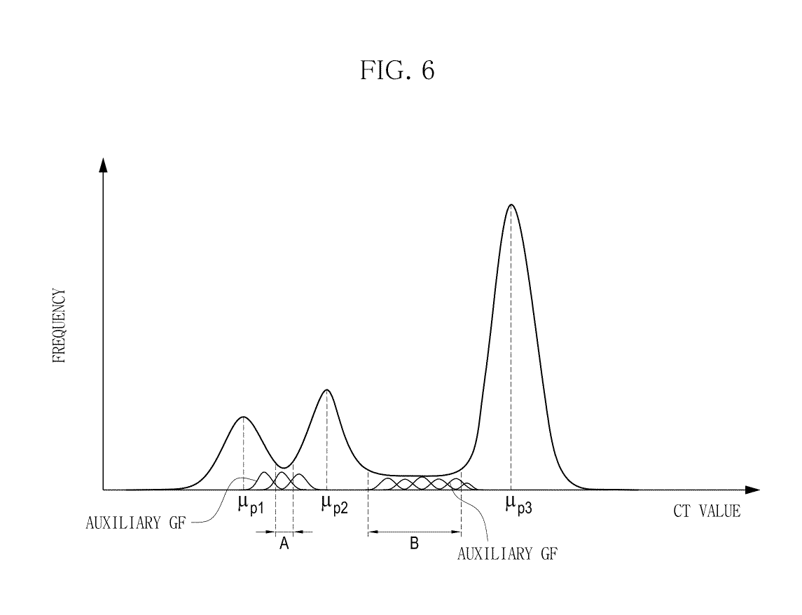

On the other hand, the X-ray histogram of the composite material does not consist of only the sum of the X-ray histograms of the pure materials. In the case of ranges indicated by region A and region B in FIG. 5, frequency has a predetermined value, so region A and region B need to be mathematically expressed, and to represent, with GFs, the entire X-ray histogram of the composite material including the ranges between the maximum points of the pure materials such as region A and region B, an additional auxiliary GF as well as the GFs of the X-ray histograms of the pure materials is further needed. FIG. 6 is an X-ray histogram showing that auxiliary GFs are present in region A and region B in the X-ray histogram shown in FIG. 5, and as shown in FIG. 6, auxiliary GFs are further needed.

Accordingly, to compute and produce the GFs representing the X-ray histogram of the composite material through multiple regression analysis, the number of additional auxiliary GFs is set (S1-3). That is, a user arbitrarily sets the number of auxiliary GFs (NF) used to yield the GFs representing the X-ray histogram of the composite material. When the number of auxiliary GFs (NF) is set, the computing device determines a mean value for each auxiliary GF by dividing a mean value interval of the GF representing the X-ray histogram between the pure materials by the number of auxiliary GFs (NF) (S1-4).

As described in the foregoing, for the pure materials that make up the composite material, by the computing process by the computing device, the mean value of the GF representing the X-ray histogram of each pure material is determined (S1-2), and the number of auxiliary GFs used to yield the GFs representing the X-ray histogram of the composite material and the mean value of each auxiliary GF is determined (S1-3 and S1-4), and then, variance values and area values used to determine the shape of the GFs representing the pure materials and the auxiliary GFs is arbitrarily set, and ‘tentative GFs’ of the composite material defined by the sum of the GFs representing each pure material and the auxiliary GFs are yielded (S1-5).

When an error between the ‘tentative GFs’ and the X-ray histogram obtained through real CT scan (the total sum of differences between values (CT value) at a predetermined interval between a minimum range and a maximum range of the horizontal axis and corresponding values of the vertical axis through the ‘tentative GFs’ and the X-ray histogram) is minimum, a combination of the variance values and the area values of the GFs of the pure materials and the auxiliary GFs is obtained. This series of computing processes is generally referred to as ‘multiple regression analysis’, and the combination of the variance values and the area values of the GFs of the pure materials and the auxiliary GFs is determined through multiple regression analysis, and the “GFs representing the X-ray histogram of the composite material” defined by the sum of them are employed (S1-6). That is, among the obtained tentative GFs, GFs with a minimum error between the X-ray histogram obtained through CT scan and vertical axis values (vertical axis corresponding values through the function or histogram curve) corresponding to a plurality of horizontal axis values are employed as the GFs representing the X-ray histogram of the composite material.

This relationship is mathematically expressed as Equation 1 below.

$$GF representing X - ray histogram of composite material = {\sum }_{J = 1}^{NF} {GF}_{j} \qquad [ Equation 1 ]$$

In the above Equation 1, NF denotes the sum of the number of pure materials and the number of auxiliary GFs, and GF_{J} which is a bell-shaped Gaussian distribution function defined by an area value, a variance value and a mean value, denotes individual GFs constituting the GFs representing the X-ray histogram of the composite material. As shown in FIG. 5, when the composite material consists of, for example, three pure materials p1, p2 and p3, and the number of auxiliary GFs is set to 17, the total number of GF_{J} (NF) equals 20 (J=1˜20), so Equation 1 is rewritten as Equation 2 below.

GF representing X-ray histogram of composite material=GF₁+GF₂+GF₃+ . . . +GF₂₀ [Equation 2]

In the above Equation 2, GF₁, GF₂, . . . denote the GFs of the pure materials and the auxiliary GFs, respectively, and have a mean value set by the above S1-2 and S1-3. Also, in the above Equation 2, the GFs representing the X-ray histogram of the composite material are a function defined by the sum of all GFs of which the shape is determined by the variance value and the area value through multiple regression analysis of the above S1-5 and S1-6.

As described in the foregoing, when the GFs representing the X-ray histogram of the composite material and the individual GFs constituting the GFs are respectively calculated and determined, the computing device estimates the volume fraction occupied by each pure material in the auxiliary GFs representing the mixel (S2).

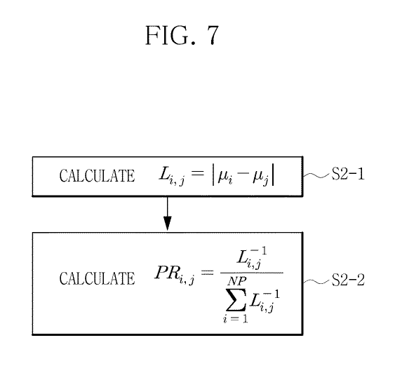

FIG. 7 is a detailed flowchart of the step for estimating the volume fraction occupied by each pure material in each GF, and as shown in FIG. 7, first, a difference between a mean value of the GF for each pure material and a mean value of each of the plurality of auxiliary GFs constituting the GFs representing the X-ray histogram of the composite material is calculated (S2-1). That is, a difference L_{i,j} between a mean value μᵢ of the GF of the i^{th} pure material among the plurality of GFs constituting the GFs representing the X-ray histogram of the composite material and a mean value μⱼ of the j^{th} GF among the plurality of GFs constituting the GFs representing the X-ray histogram of the composite material (mixel) is calculated by Equation 3 below.

L_{i,j}=|μᵢ−μⱼ| [Equation 3]

As the L_{i,j} value calculated by the above Equation 3 is smaller, the fraction of the corresponding pure material is larger. As illustrated in FIG. 5, when the number of pure materials is three, i.e., p1, p2 and p3 and the mean value of the GFs constituting the GFs representing the X-ray histogram of the composite material is close to a GF mean value of the pure material p3, in other words, when the L_{3,j} value calculated by Equation 3 is small, it implies that the fraction occupied by the pure material p3 is large.

Accordingly, after the difference between the mean value of the GF for each pure material and the mean value of each of the plurality of GFs constituting the GFs representing the X-ray histogram of the composite material is calculated, the volume fraction occupied by each pure material in each GF is calculated using the result of the calculation (S2-1). That is, after the L_{i,j} value is calculated by the above Equation 3, by using the L_{i,j} value, the volume fraction PR_{i,j} occupied by the i^{th} pure material in the j^{th} GF among the plurality of GFs constituting the GFs representing the X-ray histogram of the composite material is calculated by Equation 4 below.

$${PR}_{i , j} = \frac{{L}_{i , j}^{- 1}}{{\sum }_{i = 1}^{NP} {L}_{i , j}^{- 1}} \qquad [ Equation 4 ]$$

In the above Equation 4, L_{i,j} denotes a value calculated by Equation 3, and NP denotes the number of pure materials (the number of pure materials set by S1-1). In Equation 4, PR_{i,j} denotes the volume fraction occupied by the i^{th} pure material in the j^{th} GF among the plurality of GFs used to yield the GFs representing the X-ray histogram of the composite material in the above Equation 1.

As described in the foregoing, when for each of the plurality of GFs used to yield the GFs representing the X-ray histogram of the composite material, the volume fraction occupied by the pure material is calculated by the above Equation 4, the computing device calculates the volume fraction VF of each pure material for each voxel by Equation 5 below (S3).

$${VF}_{i} ( x ) = \frac{{\sum }_{j = 1}^{NF} {PR}_{i , j} \times {GF}_{j} ( x )}{{\sum }_{i = 1}^{NP} {\sum }_{j = 1}^{NF} {PR}_{i , j} \times {GF}_{j} ( x )} \qquad [ Equation 5 ]$$

In the above Equation 5, VFᵢ(x) denotes the volume fraction occupied by the i^{th} pure material in a voxel having the CT value of x. In Equation 5, PR_{i,j} denotes the volume fraction (calculated by Equation 4) occupied by the i^{th} pure material in the j^{th} GF among the plurality of GFs constituting the GFs representing the X-ray histogram of the composite material, and GFⱼ(x) denotes voxel frequency of the j^{th} GF in the voxel having the CT value of x. That is, GFⱼ(x) in the above Equation 5 denotes, in the plotting of an X-ray histogram graph of the j^{th} GF among the plurality of GFs constituting the GFs representing the X-ray histogram of the composite material, a value of the vertical axis when the CT value of the horizontal axis is x in the corresponding graph.

Here, in Equation 5, NP denotes the number of pure materials, and NF denotes the total number of the number of pure materials and the number of auxiliary GFs (see Equation 1).

As described above, for each voxel corresponding to a smallest unit in a CT image of a sample made from a composite material (a material composite) consisting of a mixture of a plurality of pure materials, in other words, for each voxel constituting the sample, the present disclosure calculates the volume fraction occupied by each pure material in a corresponding voxel. As previously described, as if when a digital camera takes an image of an object, the smallest units of the image “pixels” form a two dimensional (2D) image of the object, when a sample is CT scanned, the sample is regarded as a collection of smallest units of the CT image, or voxels, and according to the present disclosure, for a voxel consisting of a mixture of a plurality of pure materials, i.e., a mixel, among the voxels of the sample, the volume fraction of the pure materials of the mixture in the corresponding mixel is calculated.

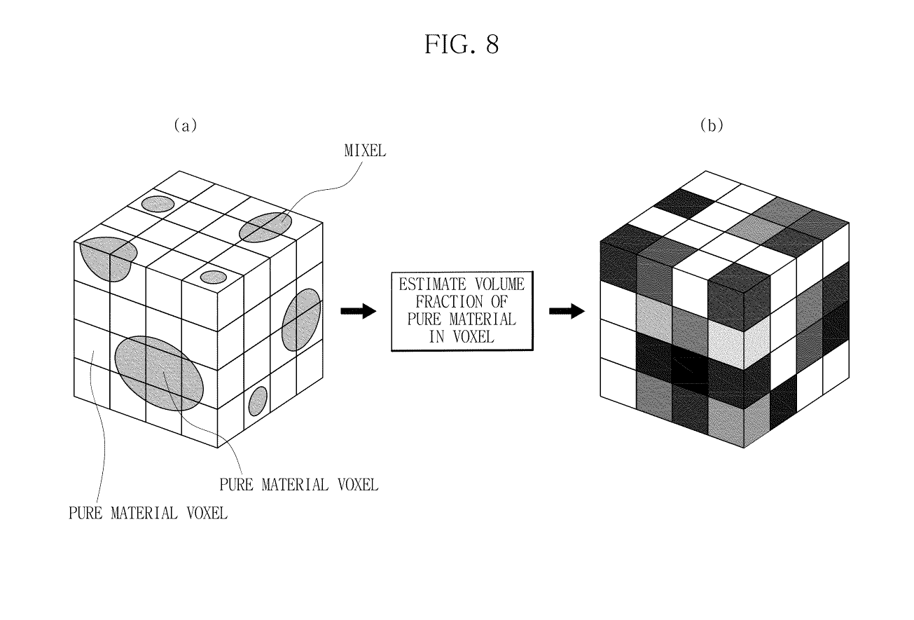

FIG. 8 is a conceptual diagram illustrating a process of classifying voxels according to the present disclosure, and when a sample is made up of a mixel and a voxel consisting of only a pure material as shown in (a) of FIG. 8, the present disclosure calculates the volume fraction of the pure materials of the mixture in the corresponding mixel, and classifies each voxel (including the mixel) based on the volume fraction of the pure materials as shown in (b) of FIG. 8.

That is, as discussed above, because conventional technology classifies voxels by dichotomy based on a set threshold, even if a mixel consisting of a mixture of different types of materials exists among voxels of a sample, the volume fraction of the pure materials of the mixture in the mixel could not be taken into account, and accordingly, even though the volume fraction of each material consisting of the sample is calculated by a known method, there was a disadvantage of low accuracy and reliability. However, for a mixel consisting of a mixture of pure materials, the present disclosure calculates the volume fraction of the pure materials of the mixture in the corresponding mixel, so when the volume fraction of each pure material of the sample is yielded by a known method based on the voxel, the volume fraction of the pure materials is accurately calculated even in the volume of one voxel unit, and there is an effect of increasing the accuracy and reliability of a mean volume fraction analysis method of the sample using CT scan.

1. An estimation method for volume fractions of pure materials in a voxel, by which for each voxel corresponding to a smallest unit in an X-ray Computed Tomography (CT) image of a specimen made from a composite material consisting of a mixture of a plurality of pure materials, volume fraction occupied by each pure material in the corresponding voxel is calculated, the method comprising:
CT scanning using X-ray penetration by CT scan equipment to obtain an X-ray histogram of the specimen made from the composite material;
Obtaining Gaussian distribution Functions (GFs) representing the X-ray histogram of the composite material obtained by the CT scanning and individual GFs constituting the GFs by using a computing device;
calculating a difference (L_{i,j}) between a mean value of a GF for each pure material and a mean value of each of the plurality of GFs constituting the GFs representing the X-ray histogram of the composite material by Equation 3, and estimating volume fraction (PR_{i,j}) occupied by each pure material in each Gaussian Function by Equation 4 using the calculated L_{i,j} value; and
calculating volume fraction (VF) of each pure material in each voxel size unit by Equation 5:
L_{i,j}=|μᵢ−μⱼ| [Equation 3]
$$\begin{matrix}{PR}_{i , j} = \frac{{L}_{i , j}^{- 1}}{{\sum }_{i = 1}^{NP} {L}_{i , j}^{- 1}} & [ Equation 4 ] \\ {VF}_{i} ( x ) = \frac{{\sum }_{j = 1}^{NF} {PR}_{i , j} \times {GF}_{j} ( x )}{{\sum }_{i = 1}^{NP} {\sum }_{j = 1}^{NF} {PR}_{i , j} \times {GF}_{j} ( x )} & [ Equation 5 ]\end{matrix}$$
where in Equation 3, Equation 4 and Equation 5, μᵢ denotes a mean value of the GF of the pure material among the plurality of GFs constituting the GFs representing the X-ray histogram of i^{th} composite material, μⱼ denotes a mean value of j^{th} GF among the plurality of GFs constituting the GFs representing the X-ray histogram of the composite material, L_{i,j} denotes a difference between μᵢ and μⱼ, NP denotes the number of pure materials, PR_{i,j} denotes volume fraction occupied by the i^{th} pure material in the j^{th} GF among the plurality of GFs constituting the GFs representing the X-ray histogram of the composite material, NF denotes a total number of the number of pure materials and the number of auxiliary GFs, VFᵢ(x) denotes volume fraction occupied by the i^{th} pure material in a voxel having a CT value of x, and GFⱼ(x) denotes voxel frequency of the j^{th} Gaussian function in the voxel having the CT value of x among the plurality of GFs constituting the GFs representing the X-ray histogram of the composite material.

2. The estimation method for volume fractions of pure materials in a voxel according to claim 1, wherein the yielding of GFs representing the obtained X-ray histogram and individual GFs constituting the GFs by the computing device is performed by:
counting the number of maximum points of the obtained X-ray histogram of the composite material, and reading a mean value of the GF representing the X-ray histogram of each pure material;
determining the number of additional auxiliary GFs, determining a mean value for each auxiliary GF, and obtaining tentative GFs of the composite material consisting of a sum of all the GFs; and
employing, among the obtained tentative GFs, GFs with a minimum error between the X-ray histogram obtained by the CT scanning and vertical axis values corresponding to a plurality of horizontal axis values, as the GFs representing the X-ray histogram of the composite material.
